(19) United States
(12) Patent Application Publication
(10) Pub. No.: US 2014/0344756 A1
(43) Pub. Date: Nov. 20, 2014

(54) INFORMATION PROCESSING APPARATUS, AND CONTROL METHOD THEREFOR

(71) Applicant: CANON KABUSHIKI KAISHA, Tokyo (JP)

(72) Inventor: Tetsuya Sato, Yokohama-shi (JP)

(21) Appl. No.: 14/276,428

(22) Filed: May 13, 2014

(30) Foreign Application Priority Data
May 15, 2013 (JP) 2013-103328

(51) Int. Cl. G06F 3/0484

(52) U.S. Cl. CPC G06F 3/04842
USPC 715/835

(57) ABSTRACT

A service execution request including information for specifying a called web application recommended by a calling web application is created, and an agent software application analyzes the service execution request and registers the information for specifying the called web application.

### BACKGROUND OF THE INVENTION

1. Field of the Invention

The present invention relates to a technology relating to an apparatus that provides a service.

2. Description of the Related Art

Conventionally, in order to transfer a process between websites, a website that accesses a function is required to know how to call the function such as an application programming interface (API) and a REST interface of the accessed website. Accordingly, the accessing website has to perform processing to cooperate with an API, a REST interface and so on of the different website under respective calling protocols.

On the other hand, there is another framework in which a website cooperates with an arbitrary web service (or a web application) without using a dedicated API. For example, a framework called Web Intents has been proposed.

### SUMMARY OF THE INVENTION

According to an aspect of the present invention, an information processing apparatus includes a receiving unit configured to receive an access from another information processing apparatus having registered in advance information identifying a service provider capable of providing a specific service, a transmitting unit configured to, in response to reception of the access, transmit to the another information processing apparatus an object selected by a user, a first instruction for causing, in a case that the object is selected by the user, a display unit to display information identifying the service provider capable of providing the registered specific service, and a second instruction for newly registering information identifying a service provider capable of providing the specific service with the another information processing apparatus, the information to be newly registered being different from the information registered in advance.

Further features of the present invention will become apparent from the following description of exemplary embodiments with reference to the attached drawings.

### BRIEF DESCRIPTION OF THE DRAWINGS

FIG. 1 illustrates a basic system configuration of Web Intents.

FIG. 2 is a sequence diagram illustrating an outline of basic operations of Web Intents.

FIG. 3 illustrates an example of a registration markup of Web Intents.

FIG. 4 illustrates an example of a basic Intent processing request of Web Intents.

FIG. 5 is a system block diagram according to a first embodiment of the present invention.

FIG. 6 illustrates a hardware configuration.

FIGS. 7A to 7C illustrate software program configurations.

FIGS. 8A to 8C illustrate table configurations.

FIG. 9 illustrates a sequence diagram illustrating an outline of operations according to the first embodiment of the present invention.

FIGS. 10A and 10B illustrate processing of a Web Intents client that creates an HTML document.

FIG. 11 illustrates an example of a user interface displayed by a web browser.

FIGS. 12A and 12B illustrate an example of a process of a web browser that registers a recommended Web Intents service.

FIGS. 13A and 13B illustrate another example of a process of a web browser that registers a recommended Web Intents service.

FIGS. 14A and 14B illustrate further another example of a process of a web browser that registers a recommended Web Intents service.

FIG. 15 is a system block diagram according to a second embodiment of the present invention.

FIGS. 16A and 16B illustrate a software program configuration of a service search server and a configuration of a table that manages it.

FIG. 17 is a sequence diagram illustrating an outline of operations according to the second embodiment of the present invention.

FIG. 18 illustrates an example of an Intent processing request according to the second embodiment of the present invention.

FIG. 19 is a flowchart illustrating operations of a computer and a service search server in a search process.

### DESCRIPTION OF THE EMBODIMENTS

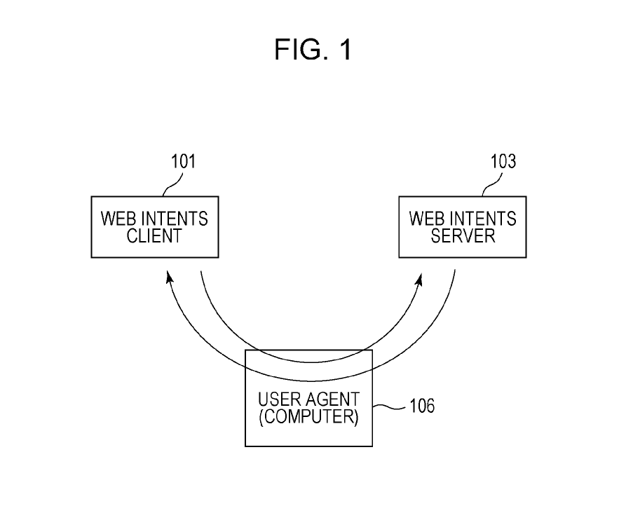

FIG. 1 illustrates an overall configuration of a Web Intents system. A Web Intents server 103 (that is an example of a service provider) provides a Web Intents service. A Web Intents client 101 is allowed to use a Web Intents service. A user agent (UA) is installed in a computer 106. It should be noted that the term “service” may be replaced by a process or a function.

Comparing social buttons “Like”, “Check”, and “Share” on SNS sites to mechanisms of Web Intents, the Web Intents server 103 is a server (such as a server of Facebook (trademark)) that provides a posting-to service such as “Like”. The Web Intents client 101 is a website having the “Like” button. The computer 106 is a computer which receives an input from a user.

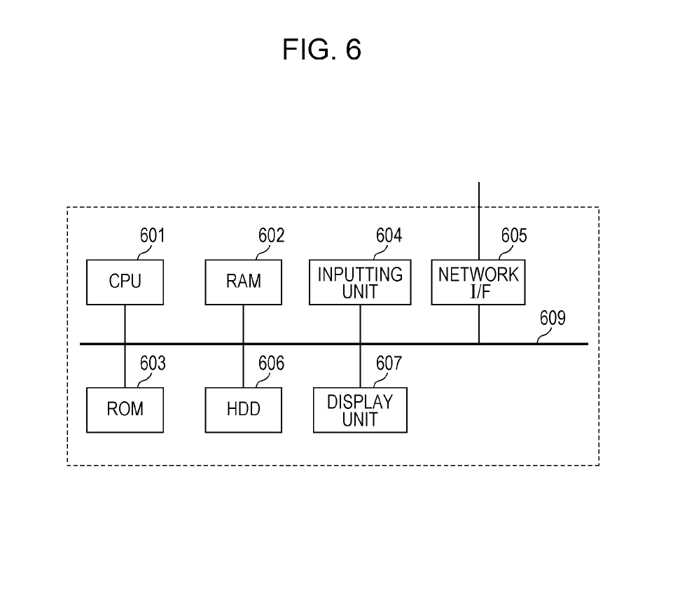

The Web Intents client 101, Web Intents server 103, and computer 106 each has a configuration of a general-purpose computer (including a CPU, a RAM, a ROM, an HDD, a display unit (such as a display), an inputting unit (such as a mouse and a keyboard), and a network interface). However, it may not have a configuration of a general-purpose computer as far as it is capable of executing processes illustrated in flowcharts which will be described below. For example, it may have a configuration of an electronic apparatus such as a smartphone, a cellular phone, a camera, a printer, a scanner, a refrigerator, or a television. Such an electronic apparatus will collectively be called an information processing apparatus herein. FIG. 6 illustrates a configuration of a general-purpose computer though it has been well known. In the following descriptions of one information processing apparatus, it may also be called “the present information processing apparatus” to refer to the information processing apparatus itself.

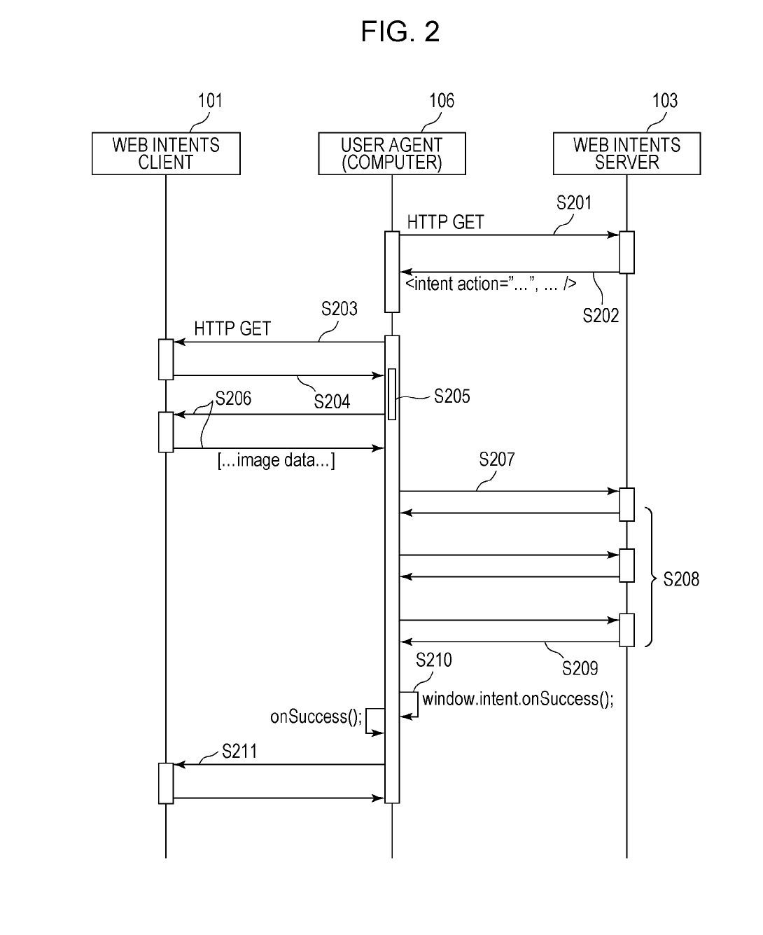

FIG. 2 is an exemplary sequence diagram of operations of the three apparatuses.

In step S201, if the computer 106 receives a URL input by a user, the computer 106 accesses a server (which is the Web Intents server 103 here) corresponding to the URL.

In step S202, the Web Intents server 103 returns an HTML (HyperText Markup Language) response including a registration markup which causes the computer 106 to register information usable for identifying a service to be provided by the server (hereinafter, called service information) to the computer 106.

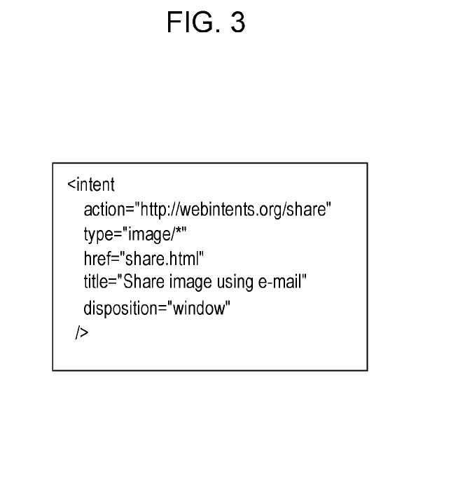

With reference to the example in FIG. 3, an HTML response to be returned from the Web Intents server 103 to the computer 106 will be described. Service information is described between <intent and >. An action indicates a type of a service, and a type indicates a format of a subject to be handled by the service. A href indicates a URL (or relative URL indicative of a service provider) to request execution of the service. A title indicates a title of the service. A disposition indicates a display form of the service. In this example, the Web Intents server 103 is allowed to “share” images of *format (i.e., any format). The “share” may sometimes be indicated as http://webintents.org/share. The URL is “share.html”, and the title is “Share image using e-mail”. Thus, the title (Share image using e-mail) of the service is displayed within a window. Having exemplarily described the relative URL (share.html) as an example of the URL, it may be an absolute URL having a longer character string by which the URL is uniquely identifiable. Alternatively, the relative URL may be used in addition to a baseURI. In this case, a combination of a relative URL and a baseURI is an absolute URL. I hold an image up as an example of a subject that the service deals with hereinafter, but the subject is not limited to an image but may be data. For example, it may be audio data. Accordingly, the wording “image” herein may be changed to “data”. The title of a service is unique within the computer 106 (that is, a plurality of service having the same title does not exist). In that sense, it may be said that a title of a service uniquely identifies a type of the service, a format of the subject, or a provider of the service.

If the computer 106 receives the response, the computer 106 executes a display corresponding to an HTML document. Specifically, a “REGISTER” button for registering a title and information on a service corresponding to the title (information on a service having the title) is displayed to ask a user whether those information pieces (that is, the information on the service) are to be registered within the computer 106 or not. If a user selects the “REGISTER” button, the computer 106 stores the information on a service having the title. For ease of description, a button will be used exemplarily here and hereinafter. However, an object to be selected by a user is not limited to a button. For example, it may be a picture object, a character object or an object like a check box, instead of a button. Accordingly, the wording “button” may be interpreted as “object” here and hereinafter.

In step S203, the computer 106 may receive a new URL input from a user and access the client (assuming that the client is the Web Intents client 101 here) corresponding to the URL. In other words, the computer 106 accesses a website corresponding to the URL and provided by the Web Intents client 101. If the website does not contain a thumbnail of the image and a “SHARE” button (a button for sharing the image), an HTML response, which will be described below, is transmitted from the Web Intents client 101 to the computer 106 (S204).

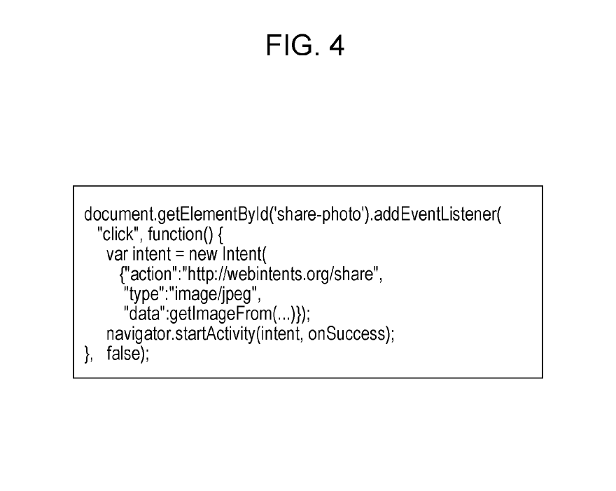

The HTML response in this case contains a thumbnail of the image, a “SHARE” button, and execution instructions for two processes corresponding to the “SHARE” button. FIG. 4 illustrates the execution instructions for two processes. Hereinafter, those execution instructions for the two processes will be collectively called as an Intent processing request.

A first process of the two processes corresponds to creation of a new Intent object and execution of a startActivety( ) function setting the created new Intent object as an argument. The new Intent object contains an action (a type of service expected to execute) and a type (a format of a subject to be handled by the service). Execution of the function by the computer 106 results in execution of the following processes by the computer 106. That is, the computer 106 searches for information on a service having the same action and type as the action and type contained in the new Intent object (hereinafter, information on a service satisfying a condition) through information on Web Intents services registered with the computer 106 and displays a title of the extracted (or retrieved by the search) service. It is apparent that the display is shown on a display unit of the computer 106 itself. It should be noted that, the term “same” above may not refer a full match as to a type. If one service supports a subject having a format specified by a type contained in a new Intent object, the service is extracted as information on a service having the same type. When a plurality of specific services each satisfies a condition, a list of titles of the plurality of services is displayed.

A second process corresponds to execution of a getImageFrom( ) function. Execution of the function by the computer 106 corresponds to acquisition of data (or subject data of the service, such as the image to be shared) held in the Web Intents client 101 from a predetermined address( . . . ) by the computer 106.

In step S205, the computer 106 receives the HTML response and displays a screen (or a website) based on the HTML response. The screen contains a thumbnail of the image and a “SHARE” button, as described above. When a user views this screen and selects the “SHARE” button, the two processes are executed. That is, the title or titles of the specific service or services satisfying the condition is or are displayed (S205), and subject data of the specific service is acquired (S206).

After that, when a user selects one of the titles in the computer 106, the computer 106 accesses a URL of the service specified by the title (S207). For example, if a title of a service provided by the Web Intents server 103 is selected from a displayed list of titles, the computer 106 accesses the Web Intents server 103. Specifically, the computer 106 execute the access by transferring an Intent processing request (or a part describing an instruct of execution of the first process of the Intent processing request, that is, a part excluding a data acquisition instruction that is an execution instruction of the second process) and the acquired image to the Web Intents server 103.

In step S208, the Web Intents server 103 extracts the Intent object from the Intent processing request and provides the service corresponding to the Intent object. In other words, a process corresponding to the Intent object is executed on the data. The operation of extracting an Intent object from an Intent processing request and providing a service corresponding to the Intent object will be called Intent processing hereinafter. It is apparent that some exchanges may occur between the Web Intents server 103 and the computer 106 to execute the process corresponding to an Intent object on the data.

When the Intent processing ends, the Web Intents server 103 transmits the processing result to the computer 106 in step S209.

When the computer 106 receives the processing result, the computer 106 in step S210 invokes and executes a callback function onSuccess( ) designated by the argument of the startActivety( ) function. The execution result is transmitted to the Web Intents client 101 in step S211. Thus, the notification that the execution result has been received is transmitted from the Web Intents client 101 to the computer 106.

Through this processing, a service (“share” an image in this example) of a Web Intents provided by the Web Intents service 103 is executed.

However, a subject of a service may not be an image, as described above. A type of service may not be sharing, but a type of service may be some processes to be performed on a subject of the service.

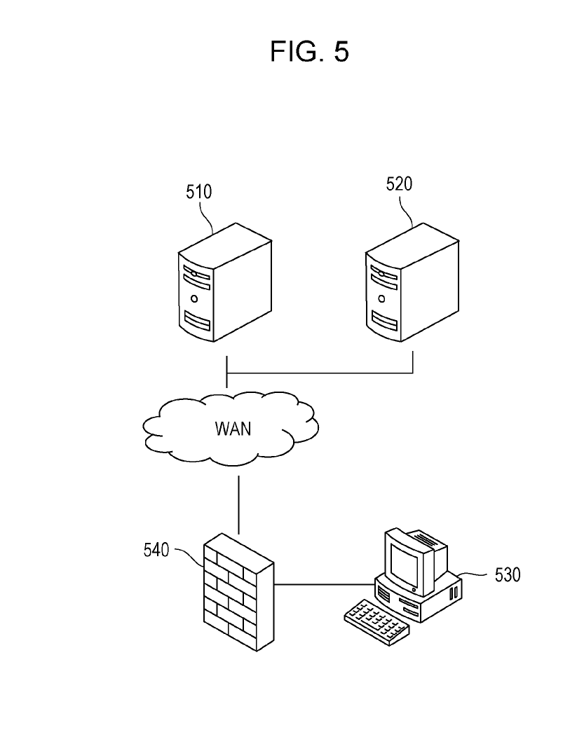

FIG. 5 illustrates a more detail system configuration of a Web Intents service. This system includes a computer 530 (corresponding to the computer 106), one or more Web Intents client 510 (corresponding to the Web Intents client 101), and one or more Web Intents server 520 (corresponding to the Web Intents server 103). A firewall 540 exists between the computer 530 and the Web Intents client 510 and Web Intents server 520.

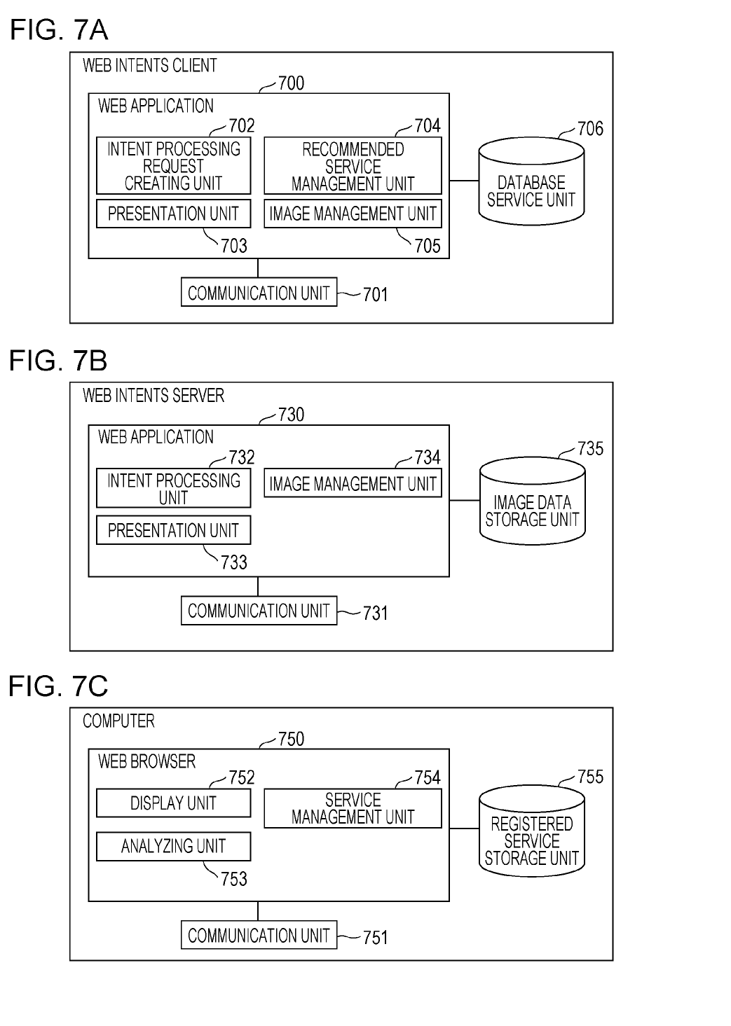

FIG. 7A illustrates a software configuration of the Web Intents client 510. In the Web Intents client 510, a web application 700, a communication unit 701, and a database service unit 706 exist as files saved in an HDD 606 in the Web Intents client 510. They are software modules (or programs) to be loaded to a RAM 602 and be executed by an operating system (OS) or other processing units using the corresponding processing units. The web application 700 is a program configured to provide a storage service such as storage of image data. The web application 700 is a program configured to respond and process a HyperText Transfer Protocol (HTTP) request. The web application 700 includes an Intent processing request creating unit 702, a presentation unit 703, a recommended service management unit 704, and an image management unit 705. The Intent processing request creating unit 702 is a program configured to create a processing request (ECMA Script) for an Intent. The presentation unit 703 is a program configured to create an HTML document in accordance with a page acquisition request received through the communication unit 701. The recommended service management unit 704 is a program configured to acquire information a Web Intents service recommended to register or use (hereinafter, called a recommended Web Intents service) from the database service unit 706. The image management unit 705 is a program configured to acquire and store image data from the database service unit 706, for example. The communication unit 701 is a program configured to receive an HTTP request message from an external apparatus and notify a content of the request to the presentation unit 703. The communication unit 701 may transmit an HTTP response message to an external apparatus. The database service management unit 706 is a program configured to manage data and store and retrieve data in accordance with a request from another processing unit. The database service management unit 706 manages a recommended Web Intents service table 801 and an image data management table 802, which will be described below. The database service management unit 706 may be a separate apparatus from the Web Intents client 510.

FIG. 7B illustrates an example of a configuration of a software program (processing unit) in the Intents server 520. In the Web Intents server 520, a web application 730, a communication unit 731, and an image data storage unit 735 exist as files saved in the HDD 606 in the Web Intents server 520. They are software programs to be loaded to the RAM 602 and be executed by an operating system (OS) or other processing units using the corresponding processing units. The web application 730 is a program configured to provide a storage service such as storage of image data. The web application 730 is a program configured to provide a Web Intents service (or execute a Web Intents process). The web application 730 may execute a process in response to an HTTP request. The web application 730 includes an Intent processing unit 732, a presentation unit 733, and an image management unit 734. The Intent processing unit 732 is a program configured to analyze and process an Intent object. The presentation unit 733 is a program configured to create an HTML document in accordance with a page acquisition request (or an HTML document acquisition request) through the communication unit 731. The image management unit 734 is a program configured to acquire and store image data from the image data storage unit 735 in accordance with a request from another processing unit. The image data storage unit 735 manages data and stores and retrieves data in accordance with a request from the image management unit 734. The communication unit 731 is a program configured to receive an HTTP request message from an external apparatus and notifies a content of the request to the presentation unit 733. The communication unit 731 transmits an HTTP response message to an external apparatus in response to a request from the presentation unit 733. In the image data storage unit 735, an image data management table 803, which will be described below, is managed. The image data storage unit 735 may be a separate apparatus from the Web Intents server 520.

FIG. 7C illustrates an example of a configuration of a software program (processing unit) in the computer 530. In the computer 530, a web browser 750, a communication unit 751, and a registered service storage unit 755 exist as files saved in the HDD 606 in the computer 530. They are programs to be loaded to the RAM 602 and be executed by an operating system (OS) or other processing units using the corresponding processing units. The web browser 750 includes a display device 752, an analyzing unit 753, and a service management unit 754. The display device 752 is a program configured to render an HTML document. The display device 752 may further display a screen for receiving a selection of a Web Intents service in accordance with a request from another processing unit. The expression “display unit displays” refers to a state that a display device causes a display unit to display here and hereinafter. The analyzing unit 753 is a program configured to analyze an HTML document. The analyzing unit 753 further analyzes an ECMA Script that is an Intent processing request. The service management unit 754 is a program configured to acquire and store information for identifying a registered Web Intents service from the registered service storage unit 755, which will be described below. The communication unit 751 is a program configured to transmit an HTTP request message to an external apparatus in response to a request from another processing unit. The communication unit 751 may receive an HTTP response message from an external apparatus and notify a content of the response to the analyzing unit 753. The registered service storage unit 755 is configured to manage data and store and retrieve data in accordance with a request from the service management unit 754. The registered service storage unit 755 manages a registered Web Intents service table 804, which will be described below.

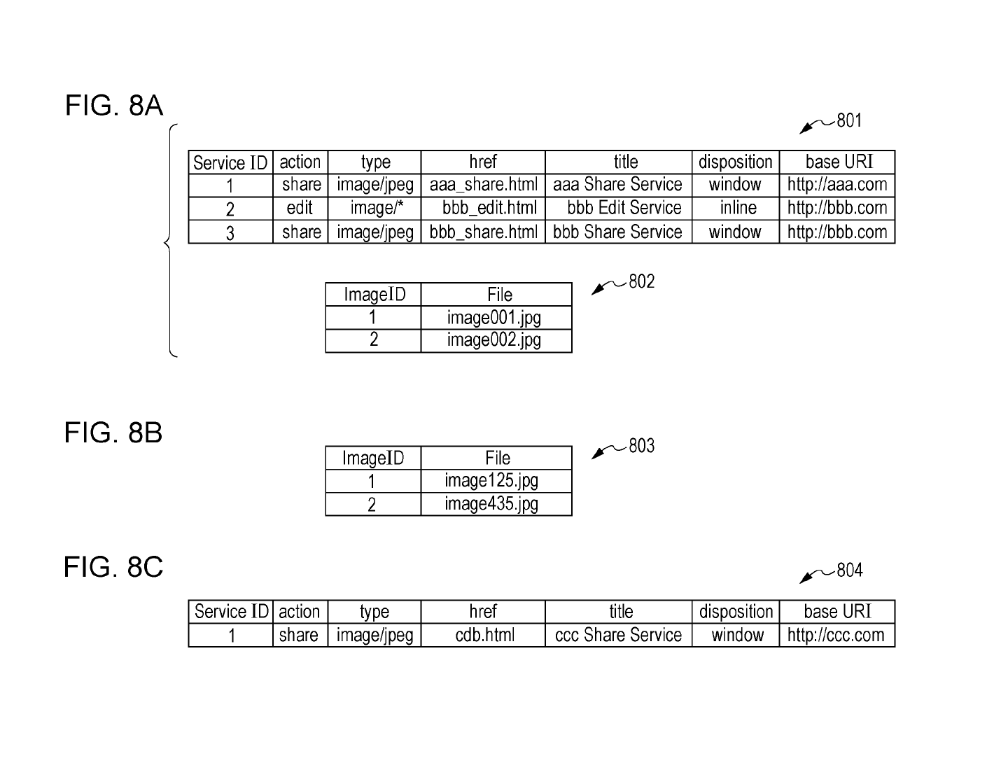

FIG. 8A illustrates an example of a table configuration managed by the database service unit 706 in the Web Intents client 510. It should be noted that the table configuration in FIG. 8A is given for illustration purpose only, and a different table configuration from the example may be provided. The database service unit 706 has a recommended Web Intents service table 801 and an image data management table 802. The recommended Web Intents service table 801 is configured to manage information on a Web Intents service recommended to use or register by the web application 700. It should be noted that information is registered in advance with the recommended Web Intents service table 801. It is assumed here, for example, that a developer or sales person in charge in a company which has developed the web application 700 registers such information in advance so as to recommend information on a Web Intents service developed by the same company. Information within the recommended Web Intents service table 801 may contain a Service ID, an action, a type, an href, a disposition, a baseURI and so on. This is substantially same information as the information describing a registration markup mentioned with reference to FIG. 3 and is usable to specify a Web Intents service.

Service ID is an ID by which a Web Intents service is uniquely identifiable within the web application 700. An action indicates a type of service, and a type indicates a format of a subject to be handled by the service. An href indicates a relative URL of a Web Intents service, and a title indicates a title of a Web Intents service. A disposition indicates a display form of a service. A baseURI is different information from the information describing a registration markup mentioned with reference to FIG. 3. A baseURI indicates a URL indicative of a reference of a Web Intents service. In other words, an absolute URL of a Web Intents service is a combination of a baseURI and an href. Referring to the first record, for example, the absolute URL of the service is http://aaa.com/aaa_share.html. According to this embodiment, an absolute URL of a Web Intents service is divided into a baseURI and an href. It is apparent however that href may store an absolute URL of a Web Intents service. These information pieces (action, type, href, title, disposition, and baseURI) stored in the table 801 will collectively be called recommended service information.

The image data management table 802 is configured to manage image data to be handled by the web application 700. Information managed by the image data management table 802 may include ImageID, File and so on. ImageID is an ID by which image data is uniquely identifiable within the web application 700. File indicates a file name of an image data. In other words, in the example of the image data management table 802, two image data files of image 001.jpg and image 002.jpg are managed.

FIG. 8B illustrates an example of a table configuration managed by the image data storage unit 735 in the Web Intents server 520. The table configuration in FIG. 8B is given for illustration purpose only, and a different table configuration from the example may be provided. The image data management table 803 is configured to manage image data to be handled by the web application 803. Information managed by the image data management table 803 may include ImageID, File and so on. ImageID is an ID by which image data is uniquely identified within the web application 730. File indicates a file name of an image data. In other words, in the example of the image data management table 803, two image data files of image 125.jpg and image 435.jpg are managed.

FIG. 8C illustrates an example of a table configuration managed by the registered service storage unit 755 in the computer 530. The table configuration in FIG. 8C is given for illustration purpose only, and a different table configuration from the example may be provided. Information for identifying a Web Intents service that may be intermediated by the web browser 750 is registered with the registered Web Intents service table 804. Specifically, data such as Service ID, action, type, href, disposition, and baseURI are registered therewith. Service ID is an ID by which a service is uniquely identifiable within the web browser 750. An action is information indicating a type of service, and a type indicates a subject of a service. An href indicates a relative URL of a Web Intents service, and a title indicates a title of a Web Intents service. A disposition indicates a display form of a Web Intents service. A baseURI indicates a URL indicative of a reference of a Web Intents service. In other words, from the example of the registered Web Intents service table 804, it may be understood that the web browser 750 is allowed to intermediate an Intent processing request to http://ccc.com/cdb.html. These information pieces (action, type, href, title, disposition, and baseURI) stored in the table 804 will collectively be called registered service information.

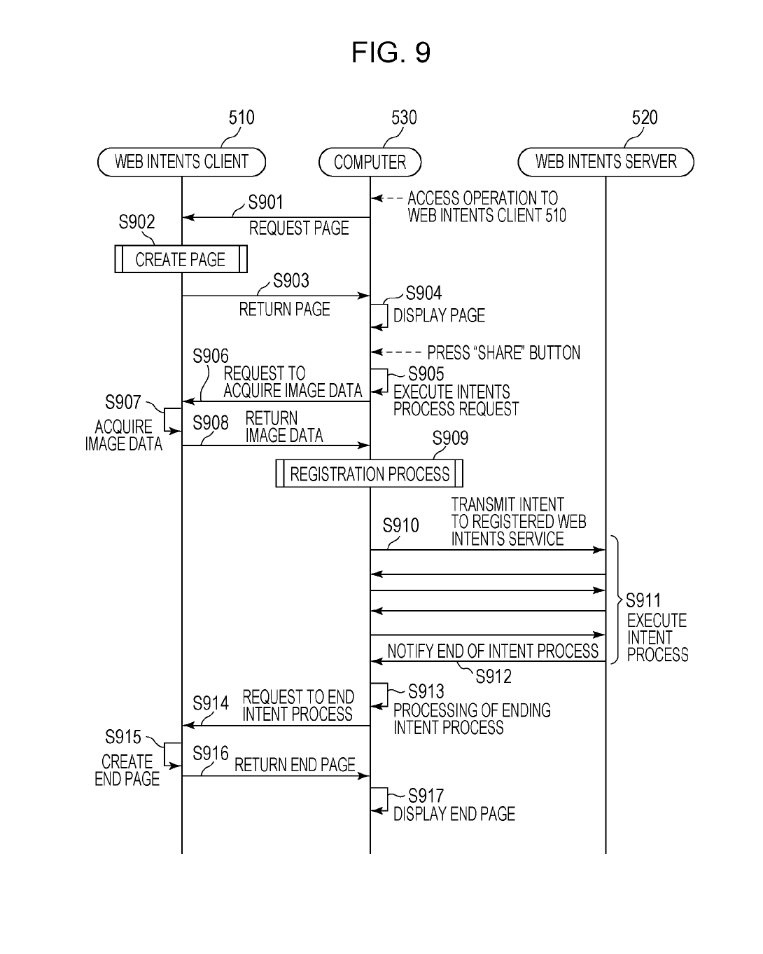

With reference to a sequence diagram in FIG. 9, operations will be described below in which the computer 530 accesses the Web Intents client 510 and intermediates an Intent processing request to the Web Intents server 520.

First, the web browser 750 of the computer 530 may receive a user operation such as input of a URL (such as http://www.abc.com/image/html) of the web application 730 on its address bar, for example, so that the following processing starts.

In step S901, the web browser 750 accesses the Web Intents client 510 through the communication unit 701. Specifically, the web browser 750 transmits an HTTP request message. The request message contains a request for transmission of a page (HTML document) corresponding to the input URL.

In step S902, the web application 700 in the Web Intents client 510 receives the page transmission request through the communication unit 701 and creates the page corresponding to the input URL.

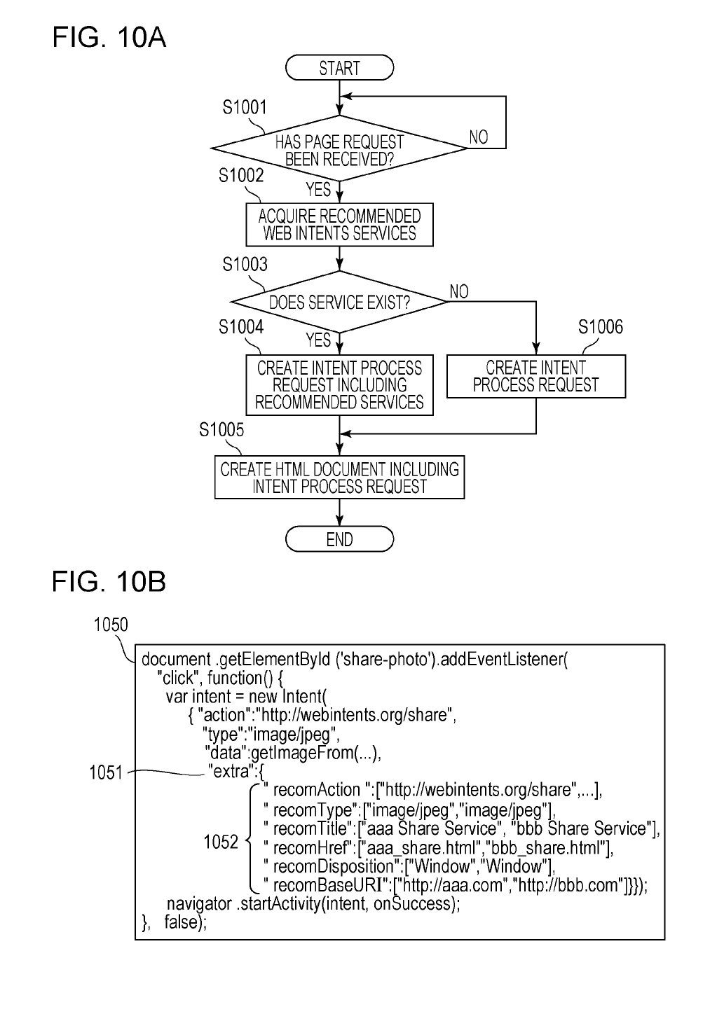

With reference to FIG. 10, the processing in step S902 in which the web application 700 creates the page will be described in detail.

FIG. 10A is a flowchart illustrating operations of the web application 700 when the web application 700 receives a page transmission request.

In step S1001, the presentation unit 703 monitors whether a page request has been received through the communication unit 701 or not. If a page transmission request has been received, the processing moves to step S1002. During a period when no page request is being received, the monitoring continues.

In step S1002, the recommended service management unit 704 acquires recommended service information from the recommended Web Intents service table 801 in the database service unit 706, and the processing moves to step S1003.

In step S1003, the presentation unit 703 determines whether recommended service information has been acquired in step S1002 or not. If one or more information pieces have been acquired, the processing moves to step S1004. If no information piece has been acquired, the processing moves to step S1006.

In step S1004, the Intent processing request creating unit 702 creates an Intent processing request (ECMA Script). An example of such a processing request will be described below with reference to FIG. 10B. It should be noted that FIG. 10B is given for illustration purpose only, and it may have other representations and notions as far as the web browser 750 may interpret it. Because an ECMA Script 1050 has a substantially same form as that of the Intent processing request in FIG. 4, differences will only be described. An extra 1051 internally contains information 1052 for identifying a recommended service. The recommended service information 1052 contains recomAction, recomType, recomTitle, recomHref, recomDisposition, and recombaseURI. These information pieces are information acquired from the recommended Web Intents service table 801. The ECMA Script 1050 in FIG. 10B contains recommended service information corresponding to Service IDs (that is, Service ID:1 and Service ID:3) in which the action is “share”, and the type is “image/jpeg”.

In step S1005, the presentation unit 703 creates an HTML document containing the Intent processing request (ECMA Script) created in step S1004 or S1006, which will be described below. The HTML document contains such an Intent processing request and information pieces 1100 to 1106 (such as a thumbnail of an image and a “SHARE” button), which will be described below.

In step S1006, the Intent processing request creating unit 702 creates an Intent processing request (ECMA Script) excluding information for identifying a recommended service, and the processing moves to step S1005. The Intent processing requests have the same form as that of the Intent processing request in FIG. 4.

The flow of the processing of creating a page in step S902 has been described.

In step S903, the web application 700 in the Web Intents client 510 transmits the page (also called an HTML document or an HTML response) created in step S902 as an HTTP response message through the communication unit 701.

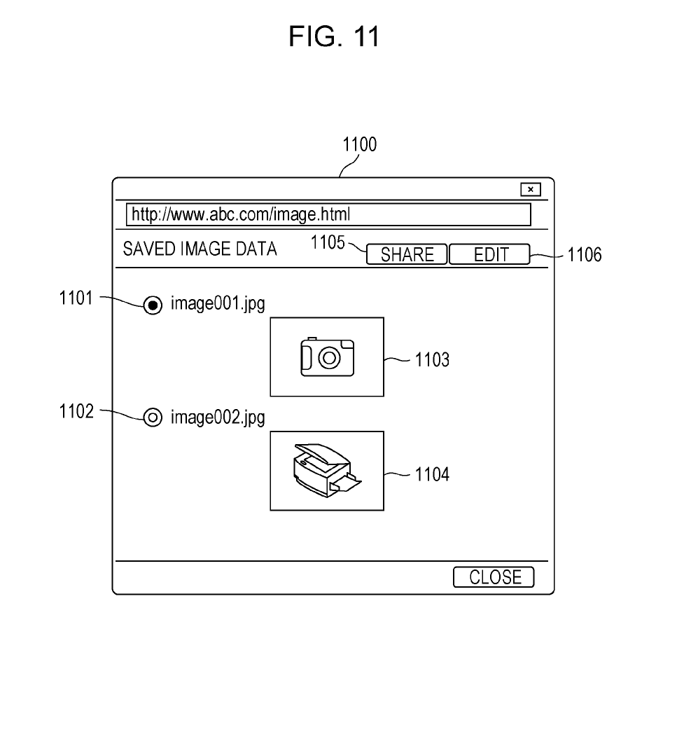

In step S904, the display device 752 of the web browser 750 in the computer 530 receives the HTML document through the communication unit 751 and displays a screen corresponding to the received HTML document. More specifically, the analyzing unit 753 analyzes the HTML document and the display device 752 displays the analyzing result on a display unit. Here, an example of a user interface to be displayed on the display unit will be described below with reference to FIG. 11.

An example of a user interface to be displayed on the display unit will be described below with reference to FIG. 11.

Radio buttons 1101 and 1102 are usable for selecting an image. The radio button 1101 is usable for selecting “image 001.jpg”. The radio button 1102 is usable for selecting “image 002.jpg”. The thumbnail 1103 is a thumbnail of image data of image 001.jpg. The thumbnail 1104 is a thumbnail of image data of image 002.jpg. A button 1105 is usable for causing a server configured to provide a Web Intents service to original image data corresponding to a thumbnail selected with a radio button so that the image data may be shared. It is assumed in this embodiment that the button 1105 is allocated an ID “share-photo” within the HTML document. In other words, the ECMA Script 1050 within the HTML document is allocated. A button 1106 is usable for causing a server configured to provide a Web Intents service to provide original image data corresponding to a thumbnail selected with a radio button so that the image data may be edited. Having described that an image to be display on the display screen is a thumbnail of an image subject to a service, it is not required to be a thumbnail. For example, it may be data themselves subject to a service. In this case, the acquisition of a subject (or data) of a service in steps S906, S907, and S908 may be omitted.

An example of a user interface to be displayed in step S904 has been described. Referring back to FIG. 9, if it is detected that a user button 1105 has been pressed, the processing moves to step S905.

In step S905, the analyzing unit 753 in the web browser 750 analyzes the ECMA Script 1050 and starts execution thereof.

In step S906, the analyzing unit 753 in the web browser 750 transmits an image acquisition request as an HTTP request message to the Web Intents client 510 through the communication unit 751. It should be noted that it is implemented by execution of a getImageFrom( ) function within the ECMA Script 1050. For example, if the radio button 1101 is selected through the user interface 1100, acquisition of image 001.jpg is requested.

In step S907, the image management unit 705 in the Web Intents client 510 receives the acquisition request through the communication unit 701. The image management unit 705 having received the request acquires image data designated in the acquisition request from the image data management table 802 in the database service unit 706. For example, if the file name of image data designated in the acquisition request for image data is “image 001.jpg”, the image data in the first record of the image data management table 802 is acquired.

In step S908, the presentation unit 703 in the Web Intents client 510 transmits the image data acquired in step S907 as an HTTP response message to the computer 530 through the communication unit 701.

In step S909, the web browser 750 in the computer 530 performs processing of registering a Web Intents service.

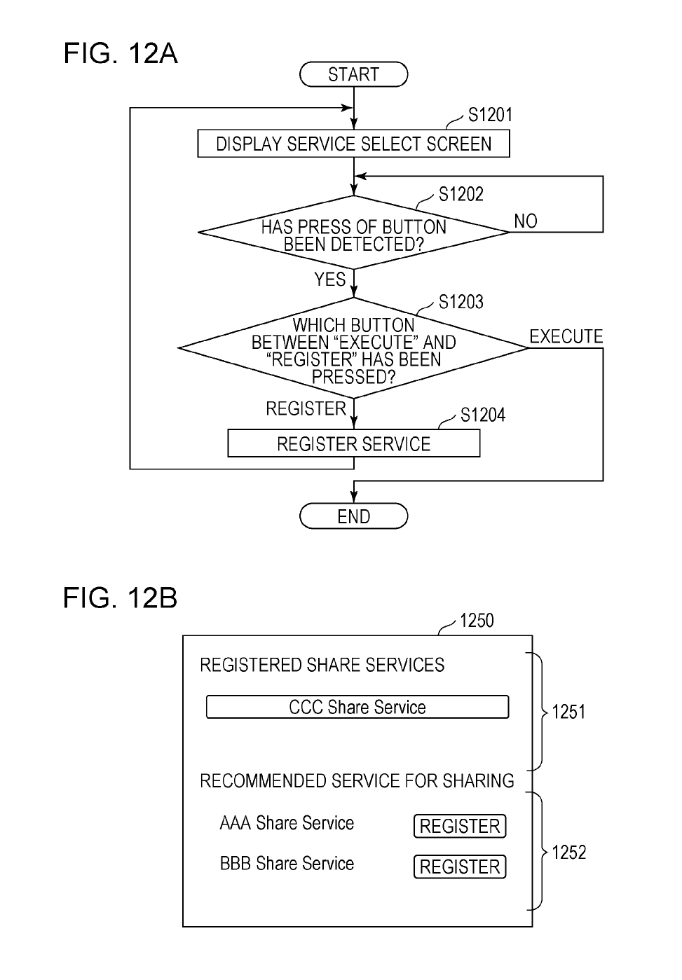

With reference to FIGS. 12A and 12B, an example of the processing of registering a Web Intents service in step S909 will be described below. FIG. 12A is a flowchart illustrating operations of the web browser 750 in the Web Intents service registering processing.

In step S1201, the following processing is performed. First, the service management unit 754 acquires information on a Web Intents service having a same action and type as the action and type designated in an Intent processing request from the registered Web Intents service table 804. For example, if the Intent processing request is the Intent processing request 1050, the action is “share”, and the type is “image/jpeg”. Thus, information on a service corresponding to the Service ID1 in the registered Web Intents service table 804 is acquired. The types may not be fully matched, as described above. Next, the analyzing unit 753 acquires recommended service information contained in the Intent processing request. The display device 752 causes a display unit to show the information on the registered Web Intents service acquired by the service management unit 754 and the recommended service information acquired by the analyzing unit 753. In a case where an Intent processing request does not contain recommended service information, a registered Web Intents service alone is displayed.

An example of a user interface shown by the display device 752 in the web browser 750 in step S1201 will be described below with reference to FIG. 12B. A user interface 1250 is displayed in response to the Intent processing request 1050. An area 1251 shows information on a registered Web Intents service on web browser 750. A button within the area 1251 is usable for causing a Web Intents server to execute processing of an Intent. An area 1252 shows a title of an un-registered, recommended service on the web browser 750. Such a title of a service corresponds to the title of a recommended service within the extra 1051 in the Intent processing request 1050. A button within the area 1252 is usable for causing the web browser 750 to register recommended service information with the registered Web Intents service table 804. An example of the service selection screen to be displayed in step S1201 has been described.

In step S1202, the display device 752 monitors whether any button has been pressed or not. If some button has been pressed, the processing moves to step S1203. During a period when no button is pressed, the monitoring continues.

In step S1203, the display device 752 determines whether the pressed button corresponds to a button for execution of a Web Intents service or a button for causing the web browser 750 to register information on a Web Intents service. If the pressed button is for the execution, the processing on the flowchart ends and moves to step S910. If the pressed button is for the registration, the processing moves to step S1204.

In step S1204, the service management unit 754 in response to the request from the display unit 754 registers recommended service information corresponding to the pressed button with the registered Web Intents service table 804 in the registered service storage unit 755. The processing then moves to step S1201. It should be noted that a title of a recommended service registered in step S1204 is displayed and is thus executable in the area 1251 on the service selection screen displayed in step S1201 to which the processing moves.

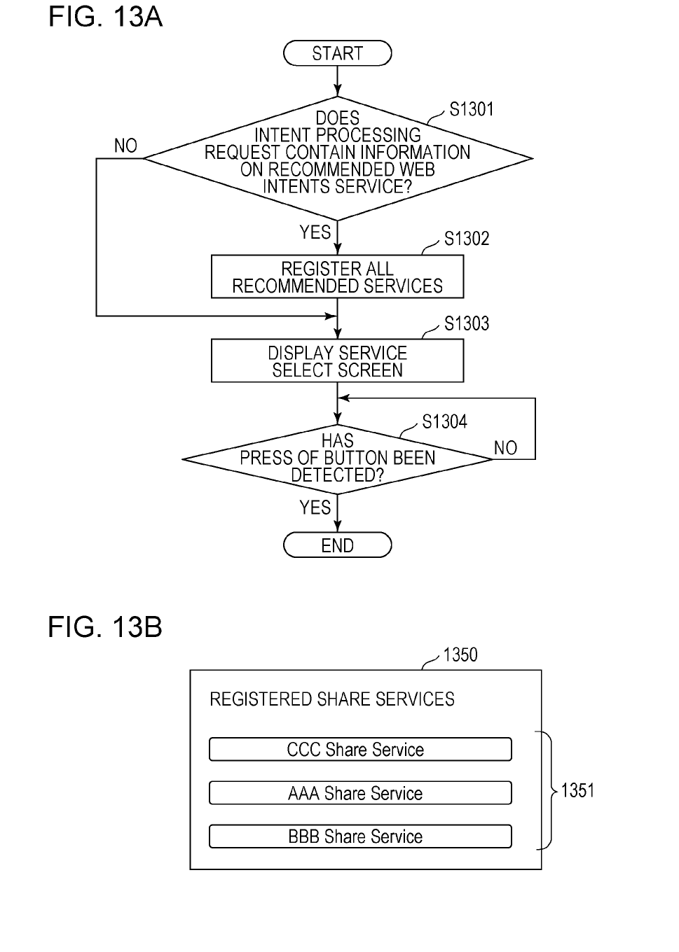

FIGS. 13A and 13B illustrate another example of the processing of registering a Web Intents service in step S909. An example of automatic registration will be described with reference to FIGS. 13A and 13B while an example of registration of information on a service selected by a user from recommended service information has been described with reference to FIGS. 12A and 12B.

FIG. 13A is a flowchart illustrating operations of the web browser 750 for automatically registering recommended service information.

In step S1301, the analyzing unit 753 determines whether a given Intent processing request contains information on a recommended Web Intents service or not. If the given Intent processing request contains information, the processing moves to step S1302. If not, the processing moves to step S1303.

In step S1302, the service management unit 754 in response to a request from the analyzing unit 753 registers recommended service information contained in the Intent processing request with the registered Web Intents service table 804 in the registered service storage unit 755. Then processing moves to step S1303. If the request is the Intent processing request 1050, information for identifying two Web Intents services having titles “aaa Share Service” and “bbb Share Service” is registered.

In step S1303, the display device 752 displays a service selection screen.

With reference to FIG. 13B, an example of the service selection screen displayed in step S1303 will be described below. A user interface 1350 is a user interface to be displayed in response to the Intent processing request 1050. A button within an area 1351 is a button usable for execution of an Intent process. The area 1351 shows a title of a Web Intents service registered with the web browser 750. Because recommended service information has already been registered by the processing in step S1302, the title of the recommended service is displayed on the area 1351 and is thus executable.

In step S1304, the display device 752 monitors whether a button on the service selection screen has been pressed or not. If the service selection screen has been pressed, the processing on the flowchart ends and moves to step S910. During a period when no button is pressed, the monitoring continues. The automatic registration of recommended service information in the aforementioned manner may reduce work of a user.

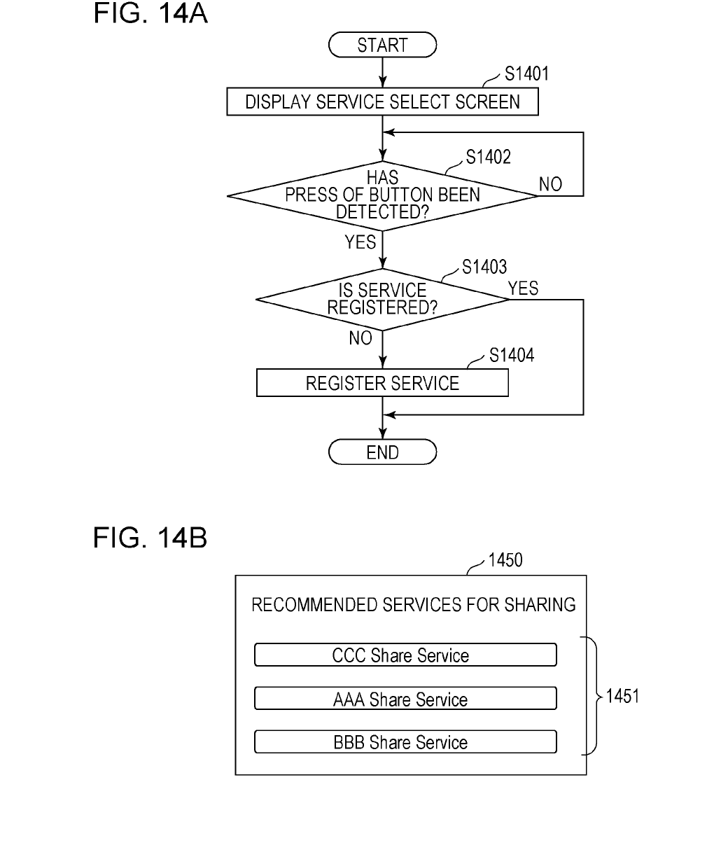

FIGS. 14A and 14B illustrate another example of the processing of registering recommended service information in step S909. Another example of registration of information on a service selected by a user from recommended service information will be described with reference to FIGS. 14A and 14B while the automatic registration of recommended service information has been described with reference to FIGS. 13A and 13B.

FIG. 14A is a flowchart illustrating operations of the web browser 750 that registers information alone on a service selected by a user.

In step S1401, the display device 752 displays a service selection screen, and the processing moves to step S1402.

An example of the service selection screen displayed in step S1401 will be described below with reference to FIG. 14B. A user interface 1450 is displayed in response to the Intent processing request 1050. An area 1451 is displayed which shows both information on a service having been registered with the web browser 750 and unregistered recommended service information. A button within the area 1451 is usable for execution of processing of an Intent.

In step S1402, the display device 752 monitors whether any button on the service selection screen has been pressed or not. If some button has been pressed, the processing moves to step S1403. During a period when no button is pressed, the monitoring continues.

In step S1403, the service management unit 754 determines whether information on a Web Intents service corresponding to the pressed button has been registered or not. If the information has been registered, the processing on the flowchart ends and moves to step S910. If not, the processing moves to step S1404.

In step S1404, the service management unit 754 registers information on a service corresponding to the pressed button with the registered Web Intents service table 804 in the registered service storage unit 755. The processing on the flowchart ends and moves to step S910. If the button “AAA Share Service” is pressed on the user interface 1450, for example, recommended service information having a title “AAA Share Service” is registered. In this manner, information on a recommended service the execution of which has been requested by a user operation may only be registered.

The processing in step S909 has been described up to this point.

Referring back to FIG. 9, the web browser 750 in the computer 530 in step S910 transmits a request for the Web Intents service selected in step S909. In this example, the request is transmitted to the web application 730 in the Web Intents server 520. In this case, the web browser 750 in the computer 530 includes in the request a content of an Intent object in the ECMA Script 1050.

In step S911, the Intent processing unit 732 in the web application 730 in the Web Intents server 520 retrieves and analyzes an Intent object from the request received in step S910 and starts execution of processing on the Intent. According to this embodiment, the web application 730 in the Web Intents server 520 provides a service of sharing image data contained in an Intent object by interacting with a user through the web browser 750 in the computer 530. For example, the web application 730 in the Web Intents server 520 may create an HTML document for receiving an input of a file name of image data and an instruction to save the image data and transmits it to the computer 530. The web browser 750 in the computer 530 may receive the HTML document and display a user interface. If the web browser 750 in the computer 530 detects the instruction to save from a user, the web browser 750 transmits a request for saving the image data to the web application 730 in the Web Intents server 520. If the web application 730 in the Web Intents server 520 receives the request for saving the image data, the image data management unit 734 registers the image data under a file name designated by a user with the image data management table 803 in the image data storage unit 735.

In step S912, when the processing for the Intent ends, the web application 730 in the Web Intents server 520 returns a response containing an ECMA Script notifying a processing result to the Web Intents client 510.

In step S913, the web browser 750 in the computer 530 executes the ECMA Script contained in the response and invokes a callback function designated by an argument of the startActivety( ) function in step S905. For example, in response to the ECMA Script 1050, a callback function “onSuccess( )” is executed.

In step S914, the web browser 750 in the computer 530 returns a processing result to the web application 700 in the Web Intents client 510 by using a callback function.

In step S915 the presentation unit 703 in the web application 700 in the Web Intents client 510 creates an end page for notifying that the processing for the Intent has ended as an HTML document.

In step S916, the presentation unit 703 in the web application 700 in the Web Intents client 510 transmits the end page created in step S915 to the computer 530 through the communication unit 701.

In step S917, the web browser 750 in the computer 530 displays the end page received in step S916.

This processing may eliminate the necessity for visiting in advance a Web Intents service to be cooperated and allows registration of a Web Intents service recommended by a cooperating Web Intents client.

### Second Embodiment

According to the first embodiment, there is provided a method in which information for identifying a recommended Web Intents service by a Web Intents client is included in an Intent processing request so that the recommended Web Intents service is registered with a web browser being a user agent. According to this embodiment, there is provided a method in which information relating to a recommended Web Intents service is included in an Intent processing request and a Web Intents service is searched for so that the recommended Web Intents service is registered with a web browser being a user agent. The description of the same parts according to this embodiment as those of the first embodiment will be omitted.

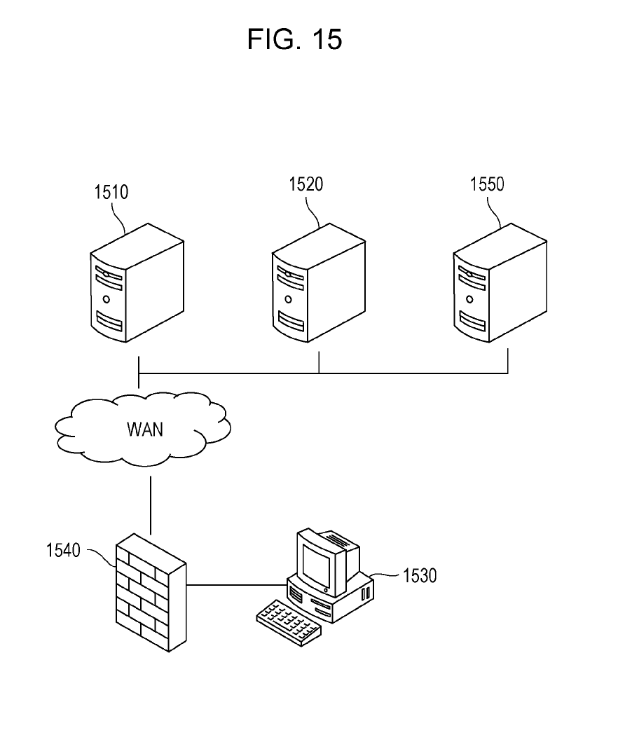

FIG. 15 illustrates an example of a system configuration of a Web Intents service that implements the present invention. The Web Intents client 1510 and Web Intents server 1520 are the same as the Web Intents client 510 and the Web Intents server 520 described according to the first embodiment. The computer 1530 and firewall 1540 are the same as the computer 530 and firewall 540 described according to the first embodiment. The system configuration according to the second embodiment is different from that of the first embodiment in that a service search server 1550 is further provided. Information for identifying a Web Intents service is registered in advance with the service search server 1550. The service search server 1550 provides a service retrieved from the registered Web Intents services in response to a search request from another apparatus. It may be configured such that the search service by the service search server 1550 may be provided by a same company as a company that provides a web browser and that a Web Intents service examined by the company is only allowed for registration, for example. Because the service search server 1550 has a configuration of a general-purpose computer and has a same hardware configuration as the configuration described with reference to FIG. 6, the description will be omitted.

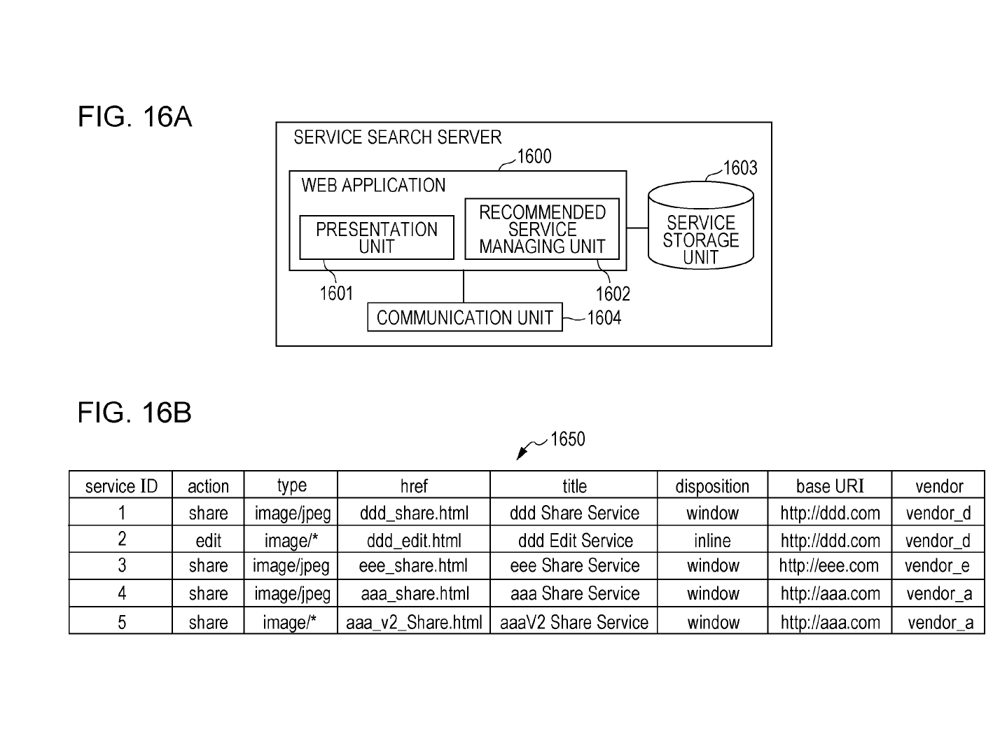

FIG. 16A illustrates an example of a configuration of a software program (processing unit) in the service search server 1550. In the service search server 1550, a web application 1600 and processing units exist as file stored in the HDD 606 in the service search server 1550. They are program modules to be loaded to the RAM 602 and be executed by other processing units using an OS and those processing units. The web application 1600 provides a service of searching for a Web Intents service. The web application 1600 is implemented as a program configured to execute a process in response to an HTTP request. The web application 1600 includes a presentation unit 1601 and a recommended service management unit 1602. The presentation unit 1601 is a software module configured to receive a search request through a communication unit 1604, which will be described below, and requests a search to the recommended service management unit 1602. The presentation unit 1601 further transmits a search result to an external apparatus being a search requestor through the communication unit 1604. The recommended service management unit 1602 is a software module configured to acquire information for identifying a Web Intents service registered with a service storage unit 1603, which will be described below. The service storage unit 1603 manages a Web Intents service table 1650, which will be described below.

FIG. 16B illustrates an example of a table configuration managed by the service storage unit 1603 in the service search server 1550. It should be noted that the table configuration in FIG. 16B is given for illustration purpose, and a different table configuration from the example may be used. The Web Intents service table 1650 manages information on a Web Intents service registered with the web application 1600. Information managed by the Web Intents service table 1650 may include Service ID, action, type, href, disposition, baseURI, vendor and so on. Service ID is an ID by which a service is uniquely identifiable within the web application 1600. An action is information describing what kind of function is provided by a service. A type is a possible subject of an action. An href indicates a relative URL of a Web Intents service, and a title indicates a title of a Web Intents service. A disposition indicates how a Web Intents service is to be displayed. baseURI indicates a URL referred by a Web Intents service. A vendor indicates a name of a company providing a Web Intents service.

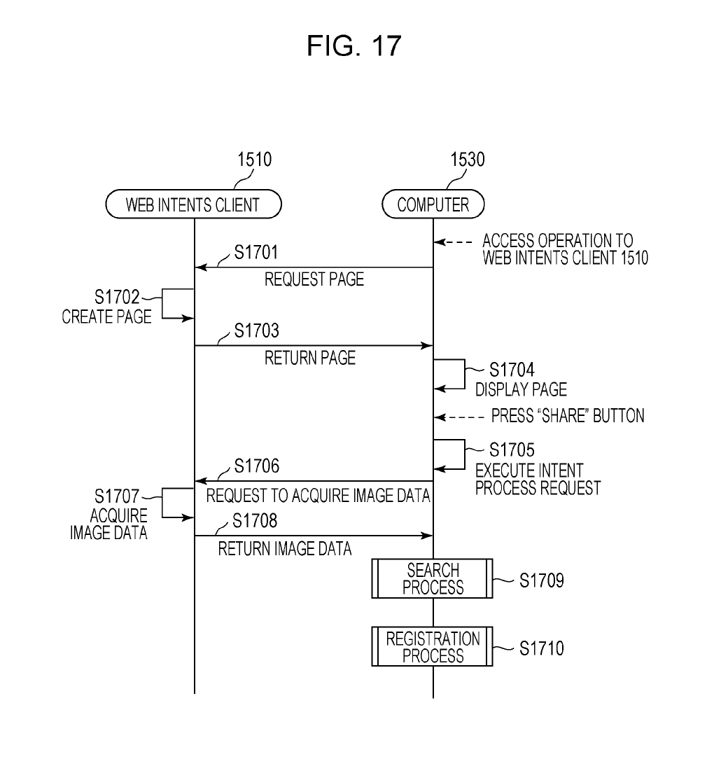

With reference to the sequence diagram in FIG. 17, operations will be described from access of the computer 1530 to the Web Intents client 1510 to registration of a recommended Web Intents service with the web browser 750 in the computer 1530.

First, when the web browser 750 in the computer 1530 receives a user operation such as an input of a URL of the web application 700 in the Web Intents client 1510 to an address bar, the following processing starts.

In step S1701, the web browser 750 in the computer 1530 transmits a request for a page as an HTTP request message to the Web Intents client 1510 through the communication unit 751.

In step S1702, the web application 700 in the Web Intents client 1510 creates a page of an HTML document containing an Intent processing request.

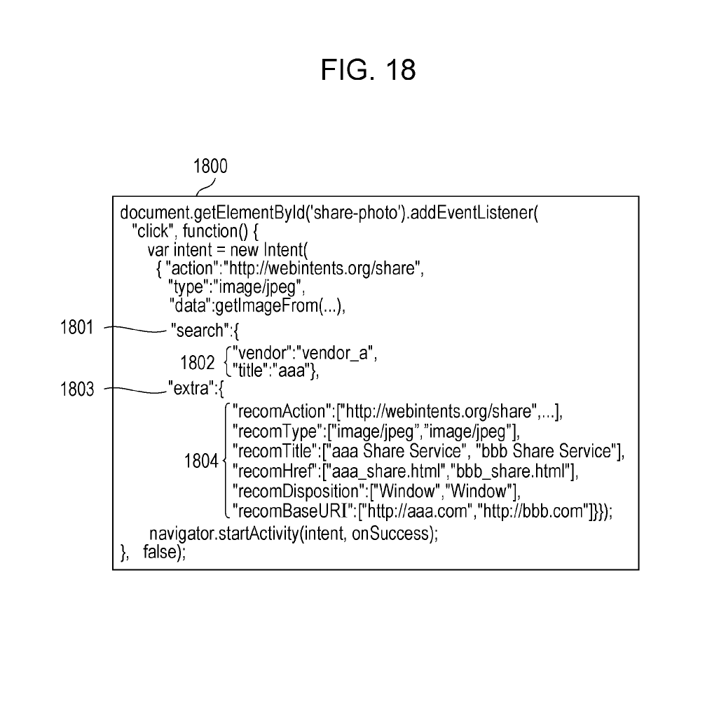

With reference to FIG. 18, an Intent processing request containing an HTML document to be created in step S1702 will be described below. It should be noted that FIG. 18 is given for illustration purpose only, and an Intent processing request may have any other form and notation as far as the web browser 750 being a user agent may interpret. FIG. 18 illustrates an ECMA Script 1800. Search 1801 internally contains information 1802 relating to a recommended Web Intents service. The information 1802 relating to a recommended Web Intents service may include vendor and title. Vendor indicates a name of a company that provides a recommended Web Intents service, and title indicates a title of a recommended Web Intents service. For vendor and title, the entire name of a company or entire title may not be required to describe, but partial name or title may be described. For example, vendor in information 1802 relating to a recommended Web Intents service may be vendor_a, and title is aaa. Accordingly a Web Intents service having vendor_a as vender and aaa included as a title is searched for in a search process, which will be described below. It should be noted that the information 1802 relating to a recommended Web Intents service may include more data other than vendor and title or may include fewer data conversely. Including more data in the information 1802 relating to a recommended Web Intents service may narrow the number of search results. Such information relating to a recommended Web Intents service is held in a program in advance by the recommended service management unit 704. It may be configured such that a separate table may be prepared for the information 1802 relating to a recommended Web Intents service in the database service unit 706 to be managed by the database service unit 706.

The information 1800 further includes extra 1803 internally containing information 1804 for identifying a recommended Web Intents service. Because the information 1804 for identifying a recommended Web Intents service is the same as the information 1052 for identifying a recommended Web Intents service is identified, the description will be omitted. The information 1804 for identifying a recommended Web Intents service is usable when a recommended Web Intents service is not searched for with the information 1802 relating to a recommended Web Intents service, as will be described below. In this example, search 1801 and extra 1803 are described. However, both of them are not required, but either one of them may only be required.

Referring back to FIG. 17, in step S1703, the web application 700 in the Web Intents client 1510 transmits the page created in step S1702 as an HTTP response message.

In step S1704, the display device 752 in the web browser 750 in the computer 1530 displays the received page. It should be noted that the example of a user interface of the page displayed in step S1704 is the same as the user interface 1100 described with reference to FIG. 11.

In step S1705, the analyzing unit 753 in the web browser 750 analyzes the ECMA Script 1800 and starts executing it.

The processing from steps S1706 to S1708 is the same as the processing from steps S906 to S908.

In step S1709, the web browser 750 in the computer 1530 searches for a recommended Web Intents service in cooperation with the service search server 1550.

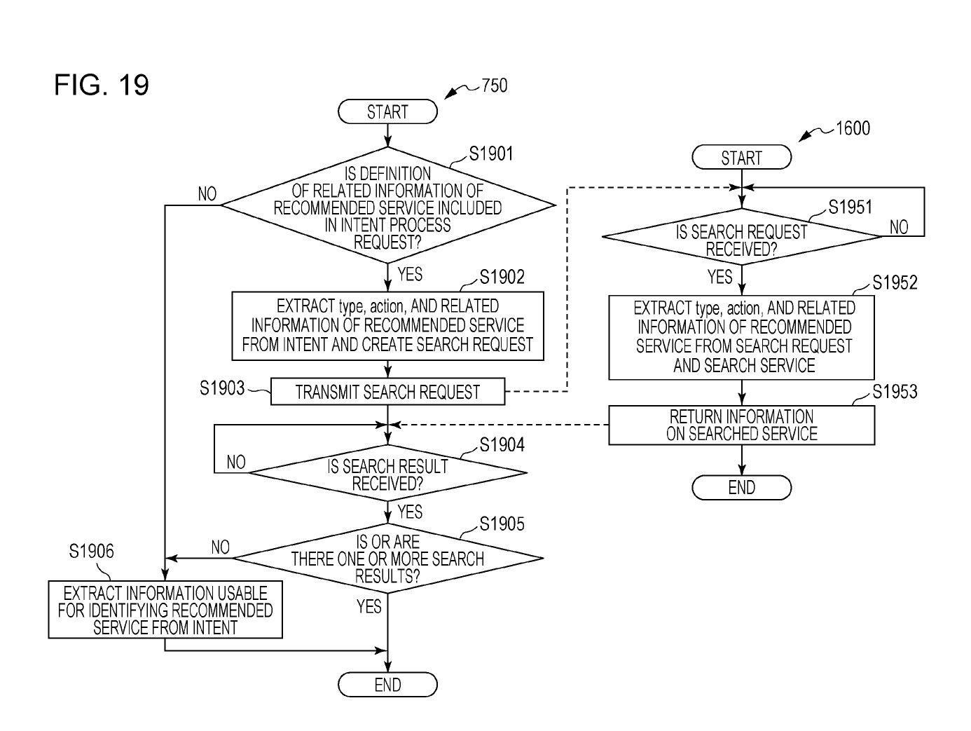

With reference to the flowchart in FIG. 19, processing will be described which is performed by the web browser 750 in the computer 1530 and the web application 1600 in the service search server 1550 in step S1709.

In step S1901, the analyzing unit 753 in the web browser 750 determines whether the Intent processing request contains information relating to a recommended Web Intents service or not. If the Intent processing request contains the information, the processing moves to step S1902. If not, the processing moves to step S1907.

In step S1902, the service management unit 754 in the web browser 750 creates a search request. The processing then moves to step S1903. More specifically, the analyzing unit 753 in the web browser 750 extracts information relating to a recommended Web Intents service, an action and a type from an Intent object and notifies it to the service management unit 754. The service management unit 754 creates a search request including information relating to the recommended Web Intents service, action and type.

In step S1903, the service management unit 754 in the web browser 750 transmits the search request created in step S1902 to the web application 1600 in the service search server 1550 through the communication unit 751. The processing them moves to step S1904.

In step S1904, the service management unit 754 in the web browser 750 monitors whether a search result has been received from the web application 1600 through the communication unit 751. If a search result has been received, the processing moves to step S1905. During a period when no search result is being received, the monitoring continues.

In step S1905, the service management unit 754 in the web browser 750 determines whether the number of search result received in step S1904 is at least one or not. If the number of search result is at least one, the processing on the flowchart ends. The Web Intents service specified by the information included in the search result is the recommended Web Intents service. If no search result has been received, the processing moves to step S1906.

In step S1906, the analyzing unit 753 in the web browser 750 extracts information for identifying the recommended Web Intents service included in the Intent processing request, and the processing on the flowchart ends. The Web Intents service identified the information extracted in step S1906 is a recommended Web Intents service.

In step S1951, the presentation unit 1601 in the service search server 1550 monitors whether a search request has been received through the communication unit or not. If a search request has been received, the processing moves to step S1952. During a period when no search request is being received, the monitoring continues.

In step S1952, the recommended service management unit 1602 in the service search server 1550 uses the information included in the search request to acquire information for identifying a Web Intents service from the service storage unit 1603, and the processing moves to step S1953. In more detail, the recommended service management unit 1602 extracts information relating to the recommended Web Intents service, action, and type from the search request. The recommended service management unit 1602 acquires information for identifying a Web Intents service matched with the information extracted from the search request from the Web Intents service table 1650 in the service storage unit 1603. For example, a case will be described where the action is “share”, the type is “image/jpeg”, the vendor of the information relating to a recommended Web Intents service is “vendor_aaa”, and the title is “aaa”. In this case, Web Intents services having Service IDs 4 and 5 are found from the Web Intents service table 1650 if it is given. Information for identifying the Web Intents services having Service IDs 4 and 5 is handled as search results.

In step S1953, the recommended service management unit 1602 transmits the search results to the web browser 750 in the computer 1530 through the communication unit in step S1952, and the processing on the flowchart ends.

The operations for the search process in step S1709 have been described.

Next, in step S1710, the web browser 750 in the computer 1530 performs processing of registering a Web Intents service. Because the example of the registration processing in step S1710 is the same as the processing described with reference to FIG. 12 to FIG. 14, the description will be omitted. Because the example of the operations for Intent processing after the registration processing in step S1710 is the same as the processing in step S910 to S917, the description will be omitted.

Through the aforementioned processing, a Web Intents service recommended by a cooperating Web Intents client may be registered also in a system configuration having a service search server.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-103328 filed May 15, 2013, which is hereby incorporated by reference herein in its entirety.

What is claimed is:

1. An information processing apparatus comprising:
a receiving unit configured to receive an access from another information processing apparatus having registered in advance information identifying a service provider capable of providing a specific service;
a transmitting unit configured to, in response to the reception of the access, transmit to the another information processing apparatus an object selected by a user;
a first instruction for causing, in a case that the object is selected by the user, a display unit to display information identifying the service provider capable of providing the registered specific service; and
a second instruction for newly registering information identifying a service provider capable of providing the specific service with the another information processing apparatus, the information to be newly registered being different from the information registered in advance.

2. The information processing apparatus according to claim 1, wherein the display unit is in the another information processing apparatus.

3. The information processing apparatus according to claim 1, wherein the specific service is sharing of data.

4. The information processing apparatus according to claim 1, wherein:
information identifying a service provider capable of providing a service is registered in advance with the another information processing apparatus;
the first instruction contains information identifying a type of the service and a format of a subject that the service is capable of handling; and
if the object is selected by the user, the another information processing apparatus
searches for information identifying a service provider having a type matching with the type and capable of handling the format through the registered information and displays information found by the search on the display unit.

5. The information processing apparatus according to claim 1, wherein the another information processing apparatus displays information on service providers retrieved based on information identifying a type of a service and a format of a subject to be handled by the service included in the first instruction in accordance with priorities based on information describing priority of the service.

6. A method for controlling an information processing apparatus, the method comprising:
receiving an access from another information processing apparatus having registered in advance information identifying a service provider capable of providing a specific service;
transmitting, in response to the reception of the access, an object selected by a user to the another information processing apparatus;
causing via a first instruction, in a case that the object is selected by the user, a display unit to display information identifying the service provider capable of providing the registered specific service; and
newly registering, via a second instruction, information identifying a service provider capable of providing the specific service with the another information processing apparatus, wherein the information to be newly registered being different from the information registered in advance.

7. The method for controlling the information processing apparatus according to claim 6, wherein the displaying is performed by the another information processing apparatus.

8. The method for controlling the information processing apparatus according to claim 6, wherein the specific service is sharing of data.

9. The method for controlling the information processing apparatus according to claim 6, wherein
information identifying a service provider capable of providing a service is registered in advance with the another information processing apparatus,
the first instruction contains information identifying a type of the service and a format of a subject that the service is capable of handling, and
wherein, if the object is selected by the user, the another information processing apparatus searches for information identifying a service provider having a type matching with the type and capable of handling the format through the registered information and displays information found by the search on the display unit.
